(19) United States
(12) Patent Application Publication
(10) Pub. No.: US 2024/0282955 A1
(43) Pub. Date: Aug. 22, 2024

(54) POSITIVE ELECTRODE ACTIVE MATERIAL FOR LITHIUM SECONDARY BATTERY, POSITIVE ELECTRODE FOR LITHIUM SECONDARY BATTERY, LITHIUM SECONDARY BATTERY, AND METHOD FOR PRODUCING POSITIVE ELECTRODE ACTIVE MATERIAL FOR LITHIUM SECONDARY BATTERY

(71) Applicant: SUMITOMO CHEMICAL COMPANY, LIMITED, Tokyo (JP)

(72) Inventor: Masashi INOUE, Niihama-shi (JP)

(73) Assignee: SUMITOMO CHEMICAL COMPANY, LIMITED, Tokyo (JP)

(21) Appl. No.: 18/567,758

(22) PCT Filed: Jun. 14, 2022
(86) PCT No.: PCT/JP2022/023720

§ 371 Date: Dec. 6, 2023

(30) Foreign Application Priority Data
Jun. 15, 2021 (JP) 2021-099484

(51) Int. Cl. H01M 4/525; C01G 53/00; H01M 4/02; H01M 4/131; H01M 10/052

(52) U.S. Cl. CPC H01M 4/525; C01G 53/42; C01G 53/50; H01M 4/131; H01M 10/052; C01P 2002/52; C01P 2002/74; C01P 2004/61; C01P 2006/12; C01P 2006/40; H01M 2004/021; H01M 2004/028

(57) ABSTRACT

In a spectrum obtained by X-ray photoelectron spectroscopy measurement of surfaces of particles of the positive electrode active material for the lithium secondary battery, the positive electrode active material has a peak X derived from a Li element having a peak top at 54.5±3.0 eV; when, upon waveform separation of the peak X derived from the Li element into a peak (A) having a peak top at 53.5±1.0 eV and a peak (a) having a peak top at 55.5±1.0 eV, an atomic ratio calculated from the peak (A), a peak derived from the Ni element, and a peak derived from the element M is defined as Li(A)/(Ni+M), and the BET specific surface area of the positive electrode active material for the lithium secondary battery measured by a nitrogen adsorption method is defined as PS, the value of {Li(A)/(Ni+M)}/PS is 0.4 to 2.6 g/m².

### TECHNICAL FIELD

The present invention relates to a positive electrode active material for a lithium secondary battery, a positive electrode for a lithium secondary battery, a lithium secondary battery, and a method for producing a positive electrode active material for a lithium secondary battery.

Priority is claimed on Japanese Patent Application No. 2021-099484, filed in Japan on Jun. 15, 2021, the content of which is incorporated herein by reference.

### BACKGROUND ART

Lithium metal composite oxides are used as positive electrode active materials for lithium secondary batteries. A method for producing a positive electrode active material for a lithium secondary battery includes a step of calcining a mixture of a metal composite compound as a precursor and a lithium compound. In the calcining step, the metal composite compound reacts with the lithium compound, and a positive electrode active material is produced. However, in the calcining step, the lithium compound may not react entirely, and a portion of the lithium compound may remain unreacted.

Patent Document 1 discloses a method of obtaining a lithium nickel composite oxide by subjecting a lithium nickel composite oxide obtained by calcination to water wash treatment, filtration, and drying.

### CITATION LIST

### Patent Document

Patent Document 1: JP-A-2007-273108

### SUMMARY OF INVENTION

### Technical Problem

With the washing method disclosed in Patent Document 1, although the unreacted lithium compound included in the lithium nickel composite oxide is removed, but lithium contained in the crystal structure of the lithium nickel composite oxide is also extracted. Thus, deficiencies of lithium ions occur on the surface portion of the crystal of the lithium nickel composite oxide, and in the case of using the lithium nickel composite oxide as the positive electrode active material for the lithium secondary battery, deterioration of the capacity is likely to progress due to repeated charging and discharging of the battery, and cycle characteristics tend to be low.

On the other hand, when the positive electrode active material is not washed after the calcining step, the unreacted lithium compound remains both inside the particles and on the surface of the particles of the positive electrode active material. A lithium secondary battery in which such a positive electrode active material is used tends to have low initial charging and discharging efficiency.

The present invention has been made in view of the above-described circumstances, and an object of the present invention is to provide a positive electrode active material for a lithium secondary battery capable of obtaining a lithium secondary battery having high initial charging and discharging efficiency and a high cycle retention rate, a positive electrode for a lithium secondary battery and a lithium secondary battery in which the positive electrode active material is used, and a method for producing a positive electrode active material for a lithium secondary battery.

### Solution to Problem

The present invention has the following aspects.
[1] A positive electrode active material for a lithium secondary battery, containing a lithium metal composite oxide containing a Ni element and an element M, and a lithium compound, in which the lithium metal composite oxide has a layered rock-salt structure, the element M represents one or more elements selected from the group consisting of Co, Mn, Fe, Cu, Ti, Mg, Al, W, Mo, Nb, Zn, Sn, Zr, Ga, B, Si, S, and P, and in a spectrum obtained by X-ray photoelectron spectroscopy measurement of surfaces of particles of the positive electrode active material for the lithium secondary battery, the positive electrode active material has a peak X derived from a Li element having a peak top at 54.5±3.0 eV; when, upon waveform separation of the peak X derived from the Li element into a peak (A) having a peak top at 53.5±1.0 eV and a peak (a) having a peak top at 55.5±1.0 eV, an atomic ratio calculated from the peak (A), a peak derived from the Ni element, and a peak derived from the element M is defined as Li(A)/(Ni+M), and a BET specific surface area of the positive electrode active material for the lithium secondary battery measured by a nitrogen adsorption method is defined as PS, a value of {Li(A)/(Ni+M)}/PS is 0.4 to 2.6 g/m².
[2] The positive electrode active material for the lithium secondary battery according to [1], in which a value of PT(Li)/PS, which is a ratio of PT(Li) that is a mass proportion of the Li element derived from the lithium compound in the positive electrode active material for the lithium secondary battery, determined by neutralization titration of a filtrate obtained by filtering a slurry obtained by mixing 5 g of the positive electrode active material for the lithium secondary battery and 100 g of pure water, to the BET specific surface area PS, is 0.1 to 1.0 mass %·g/m², and the PT(Li) is determined from an amount titrated of 0.1 N hydrochloric acid when titration is carried out with 0.1 mol/L hydrochloric acid until pH of the filtrate reaches 4.5.
[3] The positive electrode active material for the lithium secondary battery according to [2], in which the value of the PT(Li) is 0.15 to 1 mass %.
[4] The positive electrode active material for the lithium secondary battery according to any one of [1] to [3], in which the positive electrode active material for the lithium secondary battery is represented by a composition formula (I).

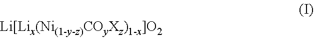

(In the formula (I), X represents one or more elements selected from the group consisting of Mn, Fe, Cu, Ti, Mg, Al, W, Mo, Nb, Zn, Sn, Zr, Ga, B, Si, S, and P, and −0.1≤x≤0.2, 0≤y≤0.2, 0<z≤0.2, and y+z≤0.3 are satisfied).
[5] The positive electrode active material for the lithium secondary battery according to any one of [1] to [4], in which the PS is 0.3 to 2 m²/g.
[6] The positive electrode active material for the lithium secondary battery according to any one of [1] to [5], in which Li/(Ni+M), which is an atomic ratio calculated from the peak X derived from the Li element, the peak derived from the Ni element, and the peak derived from the element M, is 0.8 to 8.
[7] The positive electrode active material for the lithium secondary battery according to any one of [1] to [6], in which a 50% cumulative volume particle diameter is 3 to 30 μm.
[8] A positive electrode for a lithium secondary battery, containing the positive electrode active material for the lithium secondary battery according to any one of [1] to [7].
[9] A lithium secondary battery, containing the positive electrode for the lithium secondary battery according to [8].

A method for producing a positive electrode active material for a lithium secondary battery, including a calcining step of calcining a first mixture of a metal composite compound containing a Ni element and an element M and a lithium compound to obtain an intermediate product, a mixing step of mixing the intermediate product and a liquid capable of dissolving the lithium compound to obtain a second mixture, and a drying step of evaporating the liquid from the second mixture to obtain the positive electrode active material for the lithium secondary battery, in which the element M is one or more elements selected from the group consisting of Co, Mn, Fe, Cu, Ti, Mg, Al, W, Mo, Nb, Zn, Sn, Zr, Ga, B, Si, S, and P, and when a BET specific surface area of the intermediate product is defined as IS, a mass proportion of a Li element derived from the lithium compound contained in the intermediate product is defined as IT(Li), a BET specific surface area of the positive electrode active material for the lithium secondary battery after the drying step is defined as PS, and a mass proportion of the Li element derived from the lithium compound contained in the positive electrode active material for the lithium secondary battery after the drying step is defined as PT(Li), a value of [PT(Li)/IT(Li)]/(PS/IS) is 0.1 to 0.65.

The method for producing the positive electrode active material for the lithium secondary battery according to [10], in which the value of the PT(Li)/IT(Li) is 0.8 to 1.2.

The method for producing the positive electrode active material for the lithium secondary battery according to [10] or [11], in which the liquid contains at least one of water and alcohol.

The method for producing the positive electrode active material for the lithium secondary battery according to any one of [10] to [12], in which the drying step includes heating the second mixture at 100 to 400° C.

### Advantageous Effects of Invention

According to the present invention, it is possible to provide a positive electrode active material for a lithium secondary battery capable of obtaining a lithium secondary battery having high initial charging and discharging efficiency and a high cycle retention rate, a positive electrode for a lithium secondary battery and a lithium secondary battery in which the positive electrode active material is used, and a method for producing a positive electrode active material for a lithium secondary battery.

### BRIEF DESCRIPTION OF DRAWINGS

FIG. 1 is a schematic cross-sectional view of an intermediate product in one aspect of the present embodiment.

FIG. 2 is a schematic cross-sectional view of a positive electrode active material for a lithium secondary battery in one aspect of the present embodiment.

FIG. 3 is a schematic configuration view showing an example of a lithium secondary battery in one aspect of the present embodiment.

FIG. 4 is a schematic view showing an entire configuration of the all-solid-state lithium secondary battery in one aspect of the present embodiment.

### DESCRIPTION OF EMBODIMENTS

Hereinafter, a positive electrode active material for a lithium secondary battery in an aspect of the present invention will be described. In a plurality of embodiments to be described below, preferable examples or conditions may be shared. In the present specification, terms are each defined below.

In the present specification, a metal composite compound will be hereinafter referred to as “MCC”, a lithium metal composite oxide will be hereinafter referred to as “LiMO”, and a positive electrode active material for a lithium secondary battery will be hereinafter referred to as “CAM” as an abbreviation for a cathode active material for a lithium secondary battery.

“Ni” refers not to a nickel metal but to a nickel atom. “Co”, “Li”, and the like also, similarly, each refer to a cobalt atom, a lithium atom, or the like.

In a case where a numerical range is expressed as, for example, “1 to 10 μm”, this means a range from 1 μm to 10 μm and means a numerical range including 1 μm, which is the lower limit value, and 10 μm, which is the upper limit value.

### <BET Specific Surface Area>

“BET specific surface area” is a value that is measured by the Brunauer, Emmett, and Teller (BET) method (nitrogen adsorption method). Nitrogen gas is used as the adsorbed gas in the measurement of the BET specific surface area. For example, the BET specific surface area (unit: m²/g) can be measured using a BET specific surface area meter (for example, Macsorb (registered trademark) manufactured by Mountech Co., Ltd.) after drying 1 g of a powder to be measured in a nitrogen atmosphere at 105° C. for 30 minutes.

### <Measurement of Cumulative Volume Particle Diameter>

“Cumulative volume particle diameter” is a value measured by the laser diffraction scattering method. Specifically, 0.1 g of an object to be measured, for example, a CAM powder is injected into 50 ml of a 0.2 mass % sodium hexametaphosphate aqueous solution to obtain a dispersion liquid in which the powder is dispersed. Next, the particle size distribution of the obtained dispersion liquid is measured using a laser diffraction scattering particle size distribution measuring device (for example, Microtrac MT3300EXII manufactured by MicrotracBEL Corp.) to obtain a volume-based cumulative particle size distribution curve. In the obtained cumulative particle size distribution curve, the value of the particle diameter at the time of 50% cumulation from the small particle side is the 50% cumulative volume particle diameter D₅₀ (μm).

### <Composition>

The “composition” of CAM will be analyzed by the following method. For example, the analysis can be carried out using an inductively coupled plasma emission spectrometer (for example, SPS3000 manufactured by Seiko Instruments Inc.) after CAM is dissolved in hydrochloric acid.

“Initial charging and discharging efficiency” means the ratio of the discharge capacity to the charge capacity of a lithium secondary battery in charging and discharging of the 1st cycle.

“Cycle retention rate” means a ratio of the discharge capacity of a lithium secondary battery that has been charged and discharged repeatedly to the initial discharge capacity of the lithium secondary battery after conducting a cycle test in which the lithium secondary battery is charged and discharged repeatedly a predetermined number of times under specific conditions.

In the present description, the “cycle retention rate” is measured under conditions shown below.

### <Initial Charging and Discharging>

A coin cell in which lithium metal is used for the counter electrode (negative electrode) is produced and charged and discharged under the following conditions.
Treatment temperature: 25° C.
Maximum charging voltage: 4.3 V, charging current: 0.2 CA, constant current constant voltage charging
Minimum discharging voltage: 2.5 V, discharging current: 0.2 CA, constant current discharging

### <Cycle Test>

After the initial charging and discharging test, carrying out charging and discharging under the following conditions is regarded as one cycle, and a test repeating this cycle 50 times is carried out.
Test temperature: 25° C.
Maximum charging voltage: 4.3 V, charging current: 0.5 CA, constant current constant voltage charging, finished at a current value of 0.05 CA
Minimum discharging voltage: 2.5 V, discharging current: 1 CA, constant current discharging

A value is calculated by dividing the discharge capacity in the 50th cycle by the discharge capacity in the 1st cycle, and this value is regarded as the cycle retention rate (%).

### <CAM>

CAM of the present embodiment is CAM containing LiMO containing a Ni element and an element M and a lithium compound, LiMO has a layered rock-salt structure, the element M represents one or more elements selected from the group consisting of Co, Mn, Fe, Cu, Ti, Mg, Al, W, Mo, Nb, Zn, Sn, Zr, Ga, B, Si, S, and P, and in a spectrum obtained by X-ray photoelectron spectroscopy measurement of the surfaces of the particles of CAM, CAM has a peak X derived from a Li element having a peak top at 54.5±3.0 eV; when, upon waveform separation of the peak X derived from the Li element into a peak (A) having a peak top at 53.5±1.0 eV and a peak (a) having a peak top at 55.5±1.0 eV, an atomic ratio calculated from the peak (A), a peak derived from the Ni element, and a peak derived from the element M is defined as Li(A)/(Ni+M), and the BET specific surface area of CAM measured by a nitrogen adsorption method is defined as PS, a value of {Li(A)/(Ni+M)}/PS is 0.4 to 2.6 g/m².

CAM contains LiMO containing a Ni element and an element M, and a lithium compound. The element M is one or more elements selected from the group consisting of Co, Mn, Fe, Cu, Ti, Mg, Al, W, Mo, Nb, Zn, Sn, Zr, Ga, B, Si, S, and P.

CAM in the present embodiment is an assembly of a plurality of particles. In other words, CAM in the present embodiment is powdery. In the present embodiment, the assembly of a plurality of particles may contain only secondary particles or may be a mixture of primary particles and secondary particles. That is, CAM may contain secondary particles in which primary particles of LiMO and primary particles of the lithium compound aggregate.

In the present embodiment, “primary particle” means a particle in which, apparently, no grain boundary is present at the time of observing the particle in a visual field of 1000 times or more and 30000 times or less using a scanning electron microscope or the like.

In the present embodiment, “secondary particle” is a particle in which the primary particles aggregate. That is, a secondary particle is an aggregate of primary particles.

CAM in the present embodiment contains LiMO, and the proportion of LiMO may be 95.0 to 99.9 mass % and may be 98.0 to 99.8 mass % in the total mass of CAM.

As the Li element contained in CAM, there are a Li element present in the crystal lattice of LiMO and a Li element derived from the unreacted lithium compound. The Li element present in the crystal lattice of LiMO and the Li element derived from the unreacted lithium compound can be separated and detected by X-ray photoelectron spectroscopy (XPS) measurement.

Specifically, an X-ray photoelectron spectrometer (for example, K-Alpha manufactured by Thermo Fisher Scientific Inc.) is used to measure the Li1s spectrum, the Ni2p spectrum, and the spectrum of the outermost orbital of the element M. AlKα rays are used as the X-ray source, and a neutralizing gun (acceleration voltage: 0.3 V, current: 100 μA) may be used for charge neutralization during measurement. Measurement conditions can be Spot size=400 μm, Pass Energy=50 eV, Step=0.1 eV, and Dwell time=500 ms, for example.

In the present embodiment, the Li1s spectrum obtained when the surfaces of the particles of CAM is measured by XPS is a peak derived from the Li element, which has a peak top in the range of binding energy of 54.5±3 eV. Hereinafter, a peak having a peak top in the range of 54.5±3.0 eV may be referred to as a peak X. In the present embodiment, the peak X is subjected to waveform separation into a peak (A) having a peak top at 53.5±1.0 eV and a half width of 1.0±0.2 eV and a peak (a) having a peak top at 55.5±1.0 eV and a half width of 1.5±0.3 eV.

The peak (A) is a peak derived from a Li element present in the crystal structure of LiMO, the peak (a) is a peak derived from the lithium compound present on the surfaces of the particles of CAM, and the peak X is a peak derived from the Li element present in the crystal structure of LiMO and the lithium compound present on the surfaces of the particles of CAM. Examples of the lithium compound include lithium carbonate and lithium hydroxide. Here, the surfaces of the particles of CAM means surfaces exposed to the outside.

In the present embodiment, the detection depth of XPS is several nm to 10 nm from the surfaces of the particles to be detected. Thus, the magnitude of the peak (A) corresponds to the abundance of the Li element present in the crystal lattice of the surfaces of the secondary particles of LiMO.

The peak derived from the Ni element (hereinafter, referred to as the peak Y in some cases) is the Ni2p spectrum obtained when the surfaces of the particles of CAM are measured by XPS. The peak derived from the element M (hereinafter, referred to as the peak Z in some cases) is the spectrum of the outermost orbital of the element M when the surfaces of the particles of CAM are measured by XPS. When a plurality of elements M is present, there are as many peaks Z as the number of the elements.

In a spectrum obtained by XPS measurement of the surfaces of the particles of CAM, the peak X derived from the Li element having a peak top at 54.5±3.0 eV, the peak Y derived from the Ni element, and the peak Z derived from the element M can be calculated by the following method.

The atomic concentration of the Li element can be determined by calculating the concentration of the Li element in the entire elements, as the relative value, using the peak area of each of the peaks X to Z and the sensitivity coefficient of each element. The atomic concentration of the Ni element can be determined by calculating the concentration of the Ni element in the entire elements, as the relative value, using the peak area of each of the peaks X to Z and the sensitivity coefficient of each element. The atomic concentration of the element M can be determined by calculating the concentration of the element M in the entire elements, as the relative value, using the peak area of each of the peaks X to Z and the sensitivity coefficient of each element.

In the present embodiment, the area of each of the peaks X to Z refers to the area of the mountain-shaped portion determined by the following method.
The area of the peak X: the area of the mountain-shaped portion formed between the line connecting the lowest points both on the right and left sides of the peak X and the curve of the peak X
The area of the peak Y: the area of the mountain-shaped portion formed between the line connecting the lowest points both on the right and left sides of the peak Y and the curve of the peak Y
The area of the peak Z: the area of the mountain-shaped portion formed between the line connecting the lowest points both on the right and left sides of the peak Z and the curve of the peak Z

{Li(A)/(Ni+M)}/PS, which is a ratio of the atomic ratio Li(A)/(Ni+M) calculated from the peak (A) derived from the Li element present in the crystal lattice of the surfaces of the secondary particles of LiMO, the peak Y derived from the Ni element, and the peak Z derived from the element M, measured by XPS, to the BET specific surface area of CAM (hereinafter, referred to as PS in some cases), is 0.4 to 2.6 g/m², preferably 1.0 to 2.6 g/m², and more preferably 1.5 to 2.5 g/m². When {Li(A)/(Ni+M)}/PS is 0.4 to 2.6 g/m², it is considered that deficiencies of Li in the crystal lattice of LiMO on the surfaces of the secondary particles are few and an increase in the BET specific surface area has occurred. Consequently, a decrease in the cycle retention rate due to washing is suppressed, and additionally, an increase in the initial capacity can be achieved. Then, the initial charging and discharging efficiency increases.

The reason why the above-described effect can be obtained when {Li(A)/(Ni+M)}/PS is 0.4 to 2.6 g/m² will be described. The content to be described below is only based on a presumption, and the present invention is not interpreted as being limited to the following description.

The method for producing CAM includes steps of mixing MCC containing a Ni element and the element M and a lithium compound to obtain a first mixture, then calcining the first mixture to obtain an intermediate product, and mixing the intermediate product and a liquid, and the details will be described below. In the calcining step, MCC containing the Ni element and the element M reacts with a lithium compound to produce LiMO, and the intermediate product after the calcining step also contains the unreacted lithium compound.

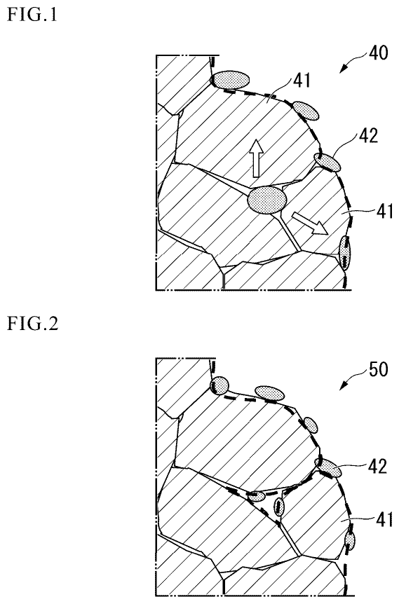

FIG. 1 is a schematic cross-sectional view of an intermediate product in one aspect of the present embodiment. FIG. 2 is a schematic cross-sectional view of CAM in one aspect of the present embodiment. An intermediate product 40 after the calcining step shown in FIG. 1 contains a lithium compound 42. The lithium compound 42 is present inside the particles of the intermediate product 40, specifically among the primary particles of LiMO 41 and on the surfaces of the particles of the intermediate product 40. The broken line shows a region contributing to the BET specific surface area of the intermediate product 40.

When mixing the intermediate product 40 and a liquid capable of dissolving the lithium compound 42, it is considered that a portion of the lithium compound 42 present inside of the particles of the intermediate product 40 dissolves in the liquid to migrate to the side of the surfaces of the particles. In FIG. 1, migration of the lithium compound 42 is schematically shown with arrows. Consequently, voids are generated inside the secondary particles, and as shown in FIG. 2, CAM 50 has an increased BET specific surface area in comparison with the intermediate product 40. Thus, the reaction area during insertion and desorption of lithium ions increases, and the initial capacity of the lithium secondary battery increases.

Additionally, CAM of the present embodiment is dried after the mixing step with a liquid, without filtration of the liquid. Thus, it is possible to suppress flowing out of the Li element present with the lithium compound in the crystal lattice of LiMO. In other words, deficiencies of the Li element present in the crystal lattice of LiMO are suppressed. A lithium secondary battery in which such CAM is used has a suppressed decrease in the cycle characteristics and has large initial charging and discharging efficiency.

PS, which is the BET specific surface area of CAM, is preferably 0.3 to 2 m²/g and more preferably 0.35 to 1 m²/g. When the BET specific surface area PS of CAM is 0.3 m²/g or more, the insertion and desorption reaction area of lithium ions increases, and the initial capacity of the lithium secondary battery increases. When the BET specific surface area PS of CAM is 2 m²/g or less, electricity is easily conducted due to contact among primary particles because gaps between primary particles are few, and the initial capacity is enabled to increase.

The value of Li(A)/(Ni+M) is preferably 0.5 to 2.0 and more preferably 1.0 to 1.9. When Li(A)/(Ni+M) is 0.5 or more, it is considered that there are few Li deficiencies in the crystal lattice in LiMO on the surfaces of the particles that may occur by washing. Consequently, a decrease in the cycle retention rate due to washing can be suppressed. When Li(A)/(Ni+M) is 2.0 or less, Li elements available for charging and discharging are moderately present on the surfaces of the particles, and thus, the initial charging and discharging efficiency is improved.

Li/(Ni+M), which is an atomic ratio of the Li element present in the crystal structure of LiMO and the Li element derived from the lithium compound present on the surfaces of the particles of CAM, Ni, and the element M, is calculated from the peak X, the peak Y, and the peak Z measured by XPS. Li/(Ni+M) is preferably 0.8 to 8, more preferably 1.5 to 7.8, and still more preferably 2.0 to 7.5. When Li/(Ni+M) is 0.6 or more, many Li elements are present on the surfaces of the particles of LiMO, and thus it is considered that Li deficiencies associated with charging and discharging are unlikely to occur. Consequently, a decrease in the cycle retention rate can be suppressed. When Li/(Ni+M) is 8 or less, Li elements available for charging and discharging are moderately present on the surfaces the particles, and thus, the initial charging and discharging efficiency is improved.

The value of PT(Li)/PS, which is the ratio of PT(Li), which is the mass proportion of the Li element derived from the unreacted lithium compound contained in CAM determined by neutralization titration to be described below, to PS, is preferably 0.1 to 1.0 mass %·g/m², preferably, 0.3 to 0.8 mass %·g/m², and more preferably more than 0.3 mass %·g/m² and 0.8 mass %·g/m² or less. When the value of PT(Li)/PS is 0.1 mass %·g/m² or more, it can be said that no deficiency of Li has not occurred on the surfaces of the particles of CAM. When the value of PT(Li)/PS is 1.0 mass %·g/m² or less, it is possible to suppress generation of gas due to the unreacted lithium compound during use of the lithium secondary battery. Also, the initial charging and discharging efficiency is enabled to increase.

The value of PT(Li) is preferably 0.15 to 1 mass %, more preferably 0.18 to 0.9 mass %, and particularly preferably 0.2 to 0.8 mass %. When the value of PT(Li) is within the above range, the surface of LiMO in CAM is in a state of being covered with the unreacted lithium compound, and deficiencies of the Li element on the surfaces of the particles of LiMO are suppressed. Consequently, a decrease in the cycle retention rate can be suppressed.

PT(Li) can be quantified by a neutralization titration method below. 5 g of CAM and 100 g of pure water are mixed to obtain a slurry. To a filtrate obtained by filtering the slurry, 0.1 mol/L hydrochloric acid is added dropwise until pH 4.5 is reached. The concentration of the Li element in the filtrate is calculated using the pH (measurement temperature: 25° C.) of 8.3 and the amount titrated of 0.1N hydrochloric acid required until pH 4.5 is reached, with an assumption that the lithium compound to react with hydrochloric acid is lithium hydroxide and lithium carbonate, thereby determining PT(Li), which is the mass proportion of the Li element derived from the unreacted lithium compound contained in CAM.

The 50% cumulative volume particle diameter (hereinafter, referred to as D₅₀ in some cases) of CAM is 3 to 30 μm, preferably 5 to 25 μm, more preferably 7 to 23 μm, and still more preferably 8 to 20 μm. When D₅₀ of CAM is 3 to 30 μm, the bulk density of CAM can be larger. When such CAM is used, the filling density of CAM increases. Therefore, an increase in the contact area of CAM and conductive particles contained in the positive electrode leads to an improvement in the conductivity. Thus, the direct current resistance of the lithium secondary battery can be reduced. Also, the cycle characteristics of the lithium secondary battery can be improved.

CAM contains LiMO containing the Li element, the Ni element, and the element M and a lithium compound. For example, CAM is represented by the following composition formula (I).

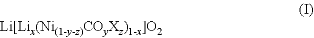

In the formula (I), X represents one or more elements selected from the group consisting of Mn, Fe, Cu, Ti, Mg, Al, W, Mo, Nb, Zn, Sn, Zr, Ga, B, Si, S, and P, and −0.1≤x≤0.2, 0≤y≤0.2, 0<z≤0.2, and y+z≤0.3 are satisfied.

From the viewpoint of obtaining a lithium secondary battery having a high cycle retention rate, x in the formula (I) is −0.1 or more, preferably −0.05 or more, more preferably more than 0, and still more preferably 0.02 or more. In addition, from the viewpoint of obtaining a lithium secondary battery having a higher initial coulombic efficiency, x in the formula (I) is 0.2 or less, preferably 0.08 or less, and more preferably 0.06 or less.

The upper limit value and lower limit value of x can be randomly combined together. As the combination, for example, x's of −0.1 to 0.2, more than 0 and 0.2 or less, −0.05 to 0.08, more than 0 and 0.06 or less, more than 0 and 0.2 or less, and the like are exemplary examples.

From the viewpoint of obtaining a lithium secondary battery having a low battery internal resistance, y in the formula (1) is 0 or more, preferably more than 0, more preferably 0.005 or more, still more preferably 0.01 or more, and even still more preferably 0.05 or more. y in the formula (I) is 0.2 or less, preferably 0.18 or less, and more preferably 0.15 or less.

The upper limit value and lower limit value of y can be randomly combined together. As the combination, for example, y's of 0 to 0.2, 0.005 to 0.18, 0.01 to 0.18, 0.05 to 0.15, more than 0 and 0.15 or less, and the like are exemplary examples.

From the viewpoint of obtaining a lithium secondary battery having a high cycle retention rate, z in the formula (I) is preferably more than 0 and 0.01 or more and more preferably 0.02 or more. In addition, z in the formula (I) is 0.2 or less, preferably 0.1 or less, and more preferably 0.05 or less.

The upper limit value and lower limit value of z can be randomly combined together. As the combination, for example, z's of more than 0 and 0.2 or less, more than 0 and 0.15 or less, 0.01 to 0.1, 0.02 to 0.05, and the like are exemplary examples.

From the viewpoint of obtaining a lithium secondary battery having a high initial capacity, the value of y+z in the formula (I) is preferably 0.3 or less, more preferably 0.25 or less, and still more preferably 0.2 or less. From the viewpoint of suppressing an increase in the resistance of the battery after the charging and discharging cycle is repeated, the value of y+z is preferably more than 0, more preferably 0.01 or more, still more preferably 0.02 or more, and even still more preferably 0.05 or more.

The upper limit value and lower limit value of y+z can be randomly combined together. The combination is, for example, more than 0 and 0.2 or less, 0.01 to 0.3, 0.02 to 0.25, 0.05 to 0.2, and the like.

From the viewpoint of obtaining a lithium secondary battery having a high cycle retention rate, X is preferably one or more elements selected from the group consisting of Mn, Ti, Mg, Al, W, B, Nb, and Zr and more preferably one or more elements selected from the group consisting of Mn, Al, W, B, Nb, and Zr.

Examples of the composition formula (I) include the following composition formula (I′).

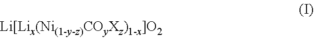

In the formula (I), X represents one or more elements selected from the group consisting of Mn, Fe, Cu, Ti, Mg, Al, W, Mo, Nb, Zn, Sn, Zr, Ga, B, Si, S, and P, and 0<x≤0.2, 0<y≤0.15, 0<z≤0.05, and 0<y+z≤ are satisfied.

The crystal structure of LiMO is a layered rock-salt structure and more preferably a hexagonal crystal structure or a monoclinic crystal structure.

The hexagonal crystal structure belongs to any one space group selected from the group consisting of P3, P3₁, P3₂, R3, P-3, R-3, P312, P321, P3₁12, P3₁21, P3₂12, P3₂21, R32, P3 m1, P31m, P3c1, P31c, R3m, R3c, P-31m, P-31c, P-3 m1, P-3c1, R-3m, R-3c, P6, P6₁, P6₅, P6₂, P6₄, P6₃, P-6, P6/m, P63/m, P622, P6₁22, P6₅22, P6₂22, P6₄₂₂, P6₃₂₂, P6mm, P6cc, P6₃cm, P63mc, P-6m2, P-6c2, P-62m, P-62c, P6/mmm, P6/mcc, P63/mcm, and P63/mmc.

In addition, the monoclinic crystal structure belongs to any one space group selected from the group consisting of P2, P2₁, C2, Pm, Pc, Cm, Cc, P2/m, P2₁/m, C2/m, P2/c, P2₁/c, and C2/c.

Among these, in order to obtain a lithium secondary battery having a high discharge capacity, the crystal structure is particularly preferably a hexagonal crystal structure belonging to the space group R-3m or a monoclinic crystal structure belonging to C2/m.

CAM described as above has suppressed deficiencies of the Li element in the crystal lattice of LiMO on the surfaces of the particles and has a large BET specific surface area. Consequently, the reaction area during insertion and desorption of lithium ions increases, and it is possible to achieve a lithium secondary battery having large initial charging and discharging efficiency as well suppressing a decrease in the cycle retention rate.

### <Method for Producing CAM>

The method for producing CAM of the present embodiment includes: a calcining step of calcining a first mixture of MCC containing a Ni element and the element M and a lithium compound to obtain an intermediate product, a mixing step of mixing the intermediate product and a liquid capable of dissolving the lithium compound to obtain a second mixture, and a drying step of evaporating the liquid from the second mixture to obtain CAM. In the method, the element M is one or more elements selected from the group consisting of Co, Mn, Fe, Cu, Ti, Mg, Al, W, Mo, Nb, Zn, Sn, Zr, Ga, B, Si, S, and P, and when the BET specific surface area of the intermediate product is represented by IS, the mass proportion of the Li element derived from the unreacted lithium compound contained in the intermediate product is defined as IT(Li), the BET specific surface area of CAM after the drying step is defined as PS, and the mass proportion of the Li element derived from the unreacted lithium compound contained in CAM after the drying step is defined as PT(Li), the value of [PT(Li)/IT(Li)]/(PS/IS) is 0.1 to 0.65.

The method for producing CAM may further include a step for producing MCC and a mixing step of MCC and a lithium compound.

The method for producing CAM of the present embodiment, with the step for producing MCC and the mixing step of MCC and a lithium compound included, will be described below.

### (1) Production of MCC

MCC may be any of a metal composite hydroxide, a metal composite oxide, and a mixture of these. The metal composite hydroxide and metal composite oxide, as an example, contain Ni, Co, and X at a molar ratio represented by the following formula (I′)

$$Ni : Co : X = ( 1 - y - z \text{):} y : z ( {I}^{′} )$$

In the formula (I′), X represents one or more elements selected from the group consisting of Mn, Fe, Cu, Ti, Mg, Al, W, Mo, Nb, Zn, Sn, Zr, Ga, B, Si, S, and P, and 0≤y≤0.2, 0<z≤0.2, and y+z≤0.3 are satisfied.

Hereinafter, a method for producing MCC containing Ni, Co, and Al will be described as an example. First, a metal composite hydroxide containing Ni, Co, and Al is prepared. Usually, the metal composite hydroxide can be produced by a well-known batch-type co-precipitation method or a continuous co-precipitation method.

Specifically, a nickel salt solution, a cobalt salt solution, an aluminum salt solution, and a complexing agent are reacted by the continuous co-precipitation method described in JP-A-2002-201028, thereby producing a metal composite hydroxide represented by Ni_{(1-y-z)}Co_{y}Al_{z}(OH)₂.

A nickel salt that is a solute of the nickel salt solution is not particularly limited, and, for example, at least one of nickel sulfate, nickel nitrate, nickel chloride, and nickel acetate can be used.

As a cobalt salt that is a solute of the cobalt salt solution, for example, at least one of cobalt sulfate, cobalt nitrate, cobalt chloride, and cobalt acetate can be used.

As an aluminum salt that is a solute of the aluminum salt solution, for example, at least one of aluminum sulfate, aluminum nitrate, aluminum chloride, and aluminum acetate can be used.

The above-described metal salts are used in ratios corresponding to the composition ratio of Ni_{(1-y-z)}Co_{y}Al_{z}(OH)₂. That is, the amount of each metal salt is specified so that the mole ratio of Ni, Co, and Al in a mixed solution containing the above-described metal salts corresponds to (1−y−z):y:z in the composition formula (I) of CAM. In addition, as the solvent, water is used.

The complexing agent is capable of forming a complex with a nickel ion, a cobalt ion, and an aluminum ion in an aqueous solution, and examples thereof include ammonium ion donors (such as ammonium hydroxide, ammonium sulfate, ammonium chloride, ammonium carbonate, or ammonium fluoride), hydrazine, ethylenediaminetetraacetic acid, nitrilotriacetic acid, uracildiacetic acid, and glycine.

In the step for producing the metal composite hydroxide, the complexing agent may or may not be used. In a case where the complexing agent is used, regarding the amount of the complexing agent that is contained in the liquid mixture containing the nickel salt solution, the cobalt salt solution, the aluminum salt solution, and the complexing agent, for example, the mole ratio of the complexing agent to the sum of the mole numbers of the metal salts (a nickel salt, a cobalt salt, and an aluminum salt) is more than 0 and 2.0 or less.

In the co-precipitation method, in order to adjust the pH value of the liquid mixture containing the nickel salt solution, the cobalt salt solution, the aluminum salt solution, and the complexing agent, an alkali metal hydroxide is added to the liquid mixture before the pH of the liquid mixture turns from alkaline into neutral. The alkali metal hydroxide is, for example, sodium hydroxide or potassium hydroxide.

The value of the pH in the present specification is defined as a value measured when the temperature of the liquid mixture is 40° C. The pH of the liquid mixture is measured when the temperature of the liquid mixture sampled from a reaction vessel reaches 40° C. In a case where the sampled liquid mixture is lower than 40° C., the liquid mixture is heated up to 40° C. and the pH is measured. In a case where the sampled liquid mixture exceeds 40° C., the liquid mixture is cooled to 40° C. and the pH is measured.

When the complexing agent in addition to the nickel salt solution, the cobalt salt solution, and the aluminum salt solution is continuously supplied to the reaction vessel, Ni, Co, and Al react with one another, and Ni_{(1-y-z)}Co_{y}Al_{z}(OH)₂ is generated.

At the time of the reaction, the temperature of the reaction vessel is controlled within a range of, for example, 20 to 80° C. and preferably 30 to 70° C.

In addition, at the time of the reaction, the pH value in the reaction vessel is controlled, for example, within a range of pH 9 to 13.

A reaction precipitate formed in the reaction vessel is neutralized under stirring. The time for the neutralization of the reaction precipitate is 1 to 20 hours, for example.

As the reaction vessel that is used in the continuous co-precipitation method, it is possible to use a reaction vessel in which the formed reaction precipitate is caused to overflow for separation.

In a case where the metal composite hydroxide is produced by the batch-type co-precipitation method, examples of the reaction vessel include a reaction vessel not equipped with an overflow pipe, a device equipped with a concentration tank connected to the overflow pipe and having a mechanism in which a reaction precipitate that has overflowed is concentrated in a concentration tank and circulated to the reaction vessel again and the like.

A variety of gases, for example, an inert gas such as nitrogen, argon, or carbon dioxide, an oxidizing gas such as an air or oxygen, or a gas mixture thereof may be supplied into the reaction vessel.

After the above-described reaction, the neutralized reaction precipitate is isolated. For isolation, for example, a method in which a slurry containing the reaction precipitate (that is, co-precipitate slurry) is dehydrated by centrifugation, suction filtration, or the like is used.

The isolated reaction precipitate is washed, dehydrated, dried, and sieved, and the metal composite hydroxide containing Ni, Co and Al is obtained.

The reaction precipitate is preferably washed with water or an alkaline washing liquid. In the present embodiment, the reaction precipitate is preferably washed with an alkaline washing liquid and more preferably washed with an aqueous solution of sodium hydroxide. In addition, the reaction precipitate may be washed using a washing liquid containing a sulfur element. As the washing liquid containing a sulfur element, a sulfate aqueous solution of potassium or sodium or the like is an exemplary example.

When MCC is a metal composite oxide, the metal composite hydroxide is heated to produce a metal composite oxide. Specifically, the metal composite hydroxide is heated at 400 to 700° C. If necessary, a plurality of heating steps may be carried out. The heating temperature in the present specification means the set temperature of a heating device. In the case of having a plurality of heating steps, the heating temperature means the temperature when the metal composite hydroxide is heated at the highest holding temperature among individual heating steps.

The heating temperature is preferably 400 to 700° C. and more preferably 450 to 680° C. When the heating temperature is 400 to 700° C., the metal composite hydroxide is sufficiently oxidized, and a metal composite oxide having a BET specific surface area in an appropriate range can be obtained. When the heating temperature is lower than 400° C., there is a concern that the metal composite hydroxide may not be sufficiently oxidized. When the heating temperature exceeds 700° C., there is a concern that the metal composite hydroxide may be excessively oxidized and the BET specific surface area of the metal composite oxide may become too small.

The time for holding at the above-described heating temperature is, for example, 0.1 to 20 hours and preferably 0.5 to 10 hours. The temperature rising rate up to the heating temperature is, for example, 50 to 400° C./hour. In addition, as the heating atmosphere, it is possible to use air, oxygen, nitrogen, argon, or a gas mixture thereof.

The inside of the heating device may be under an appropriate oxygen-containing atmosphere. The oxygen-containing atmosphere may be a gas mixture atmosphere of an inert gas and an oxidizing gas or may be in a state in which an oxidizing agent is present in an inert gas atmosphere. When the inside of the heating device is an appropriate oxygen-containing atmosphere, a transition metal that is contained in the metal composite hydroxide is appropriately oxidized, which makes it easy to control the form of the metal composite oxide.

As oxygen or the oxidizing agent in the oxygen-containing atmosphere, a sufficient number of oxygen atoms need to be present in order to oxidize the transition metal.

In a case where the oxygen-containing atmosphere is a gas mixture atmosphere of an inert gas and an oxidizing gas, the atmosphere in the reaction vessel can be controlled by a method in which an oxidizing gas is aerated into the heating device, a method in which an oxidizing gas is bubbled through a liquid mixture, or the like.

As the oxidizing agent, it is possible to use a peroxide such as hydrogen peroxide, a peroxide salt such as permanganate, perchloric acid, hypochlorous acid, nitric acid, halogen, ozone, or the like.

MCC can be produced by the step described above.

### (2) Mixing of MCC and Lithium Compound

The present step is a step of mixing MCC containing the Ni element and the element M (M is Co and Al in this description) and a lithium compound to obtain a first mixture.

The MCC is dried and then mixed with the lithium compound. After dried, the MCC may be appropriately classified.

As the lithium compound that is used in the present embodiment, it is possible to use at least any one of lithium carbonate, lithium nitrate, lithium acetate, lithium hydroxide, lithium oxide, lithium chloride, and lithium fluoride. Among these, any one of lithium hydroxide and lithium carbonate or a mixture thereof is preferable. In addition, in a case where lithium hydroxide contains lithium carbonate, the content of lithium carbonate in lithium hydroxide is preferably 5 mass % or less.

The lithium compound and MCC are mixed in consideration of the composition ratio of a final target product to obtain a first mixture. Specifically, the lithium compound and MCC are mixed at ratios corresponding to the composition ratio of the composition formula (I) described above. The amount (mole ratio) of Li to the total amount 1 of the metal atoms contained in MCC is preferably 0.98 or more, more preferably 1.04 or more, and particularly preferably 1.05 or more. The first mixture is calcined as described later, whereby a calcined product is obtained. The upper limit value of the amount of Li to the total amount 1 of the metal atoms contained in MCC (mole ratio) is preferably 1.20 or less and more preferably 1.10 or less.

### (3) Calcining of First Mixture

The present step is a calcining step of calcining a first mixture to obtain an intermediate product (hereinafter, referred to as the calcining step in some cases).

The calcining temperature is not particularly limited, but is, for example, preferably 650 to 900° C., more preferably 680 to 850° C., and particularly preferably 700° C. to 820° C. When the calcining temperature is 650° C. or higher, it is possible to obtain CAM having a strong crystal structure. In addition, when the calcining temperature is 900° C. or lower, it is possible to reduce the volatilization of lithium ions on the surfaces of the particles of CAM.

In the present specification, the calcining temperature means the temperature of the atmosphere in a calcining furnace and means the highest temperature of the holding temperatures in the main calcining step (hereinafter, referred to as the highest holding temperature in some cases). In the case of the main calcining step having a plurality of heating steps, the calcining temperature means the temperature in heating at the highest holding temperature among individual heating steps. The upper limit value and lower limit value of the calcining temperature can be randomly combined together.

When the holding time in the calcining is adjusted, it is possible to control the primary particle diameter of CAM to be obtained within a preferable range of the present embodiment. As the holding time becomes longer, there is a tendency that the primary particle diameter becomes larger and the BET specific surface area becomes smaller. The holding time in the calcining may be appropriately adjusted depending on the kind of a transition metal element used and the kinds and amounts of a precipitant.

Specifically, the holding time in the calcining is preferably 3 to 50 hours and more preferably 4 to 20 hours. When the holding time in the calcining exceeds 50 hours, there is a tendency that the battery performance substantially deteriorates due to the volatilization of lithium ions. When the holding time in the calcining is shorter than 3 hours, there is a tendency that the development of crystals is poor and the battery performance becomes poor.

In the present embodiment, the temperature rising rate in the heating step in which the highest holding temperature is reached is preferably 80° C./hour or faster, more preferably 100° C./hour or faster, and particularly preferably 150° C./hour or faster. The temperature rising rate in the heating step in which the highest holding temperature is reached is calculated from the time taken while the temperature begins to be raised and then reaches a holding temperature in the calcining device.

The calcining step preferably has a plurality of calcining stages that is carried out at different calcining temperatures. For example, the calcining step preferably has a first calcining stage and a second calcining stage of calcining at a higher temperature than in the first calcining stage. Furthermore, the calcining step may have a calcining stage that is carried out at a different calcining temperature and for a different calcining time.

As the calcining atmosphere, air, oxygen, nitrogen, argon, a gas mixture thereof, or the like is used depending on a desired composition, and a plurality of calcining steps is carried out if necessary.

The mixture of MCC and the lithium compound may be calcined in the presence of an inert melting agent. The inert melting agent is added to an extent that the initial capacity of a battery in which CAM is used is not impaired, and may remain in the calcined product. As the inert melting agent, one described in WO2019/177032A1 can be used.

The first mixture may be preliminary calcined before the calcining step is carried out. In the present embodiment, preliminary calcining is calcining at a temperature lower than the calcining temperature in the calcining step. As the calcining temperature during the preliminary calcining, for example, a range of 400° C. or higher and less than 700° C. is an exemplary example. As the calcining time during the preliminary calcining, for example, 1 to 10 hours is an exemplary example. The preliminary calcining may be carried out a plurality of times.

A calcining device to be used during the preliminary calcining is not particularly limited, and for example, either of a continuous calcining furnace or a fluidized calcining furnace may be used. As the continuous calcining furnace, a tunnel furnace or a roller hearth kiln is an exemplary example. As the fluidized calcining furnace, a rotary kiln may be used.

When the first mixture is calcined as described above, the intermediate product can be obtained.

### (4) Mixing of Intermediate Product and Liquid

After the calcining step, the intermediate product and a liquid is mixed. It is considered that this mixing step allows the unreacted lithium compound present inside the particles of CAM to migrate to the surfaces of the particles.

The liquid to be mixed with the intermediate product is a liquid capable of dissolving the lithium compound and preferably contains at least one of water and alcohol. The liquid may be pure water or may be an alkaline aqueous solution. As the alkaline aqueous solution, for example, aqueous solutions of one or more anhydrides selected from the group consisting of lithium hydroxide, lithium carbonate, and ammonium carbonate and a hydrate thereof can be exemplary examples. In addition, as the alkaline aqueous solution, ammonia water can also be used.

The temperature of the liquid is preferably 30° C. or lower, more preferably, 25° C. or lower, and still more preferably 10° C. or lower. When the temperature of the liquid is controlled within the above-described range to an extent that the liquid does not freeze, it is possible to suppress the excessive elution of lithium ions from the crystal lattice of LiMO into the liquid.

As a method for bringing the liquid and the intermediate product into contact with each other, a method in which the liquid is added to the intermediate product and mixed is an exemplary example.

It is preferable to bring the liquid and the intermediate product into contact with each other for an appropriate range of time. “Appropriate time” refers to a time long enough to allow the unreacted lithium compound present inside the secondary particles of CAM to migrate to the surfaces of the secondary particles, and is preferably adjusted depending on the aggregation state of the intermediate product. The time for mixing the liquid and the intermediate product to bring them into contact with each other is particularly preferably, for example, in a range of 0.05 hours or longer and 1 hour or shorter.

The proportion of the liquid with respect to the total mass of the mixture of the liquid and the intermediate product (hereinafter, referred to as the second mixture in some cases) is preferably 3 to 20 mass %, more preferably 5 to 18 mass %, and particularly preferably 6 to 15 mass %. When the proportion of the liquid with respect to the total mass of the second mixture is 3 to 20 mass %, the excessive elution of lithium ions from the crystal lattice of LiMO into the liquid can be suppressed, and additionally the unreacted lithium compound present inside the secondary particles of CAM is enabled to migrate to the surfaces of the secondary particles.

In the mixing step of the liquid and the intermediate product, the second mixture is particularly preferably stirred in a clay-like state or paste-like state. When the second mixture is clay-like or paste-like, liquid is present among gaps of the powder of the intermediate product, and thus the intermediate product and the liquid can be efficiently mixed. The mixture being clay-like means a state in which the powder aggregates due to intervention of the liquid among the particles of the intermediate product to result in aggregates of 1 mm or more. The mixture being paste-like means a state in which the mixture may flow due to intervention of the liquid among the particles of the intermediate product. When the proportion of the liquid with respect to the total mass of the mixture of the liquid and the intermediate product is 3 to 20 mass %, the second mixture is more likely to be clay-like or paste-like. When the second mixture is clay-like or paste-like, the mixture is in an aggregation state. Thus, the surface area in contact with the atmosphere is reduced, a carbon dioxide gas is unlikely to be absorbed from the atmosphere, and PT(Li)/IT(Li), which is the ratio of the amount of the lithium compound of the positive electrode active material to the amount of the lithium compound of the intermediate product, can be controlled within a preferable range.

The value of PT(Li)/IT(Li) is preferably 0.8 to 1.2, more preferably 0.85 to 1.15, and particularly preferably 0.9 to 1.1. The value of PT(Li)/IT(Li) larger than the upper limit value means that the Li element is desorbed from the crystal structure of LiMO when the amount of the lithium compound increases, and the cycle characteristics of a battery are likely to deteriorate. The value of PT(Li)/IT(Li) smaller than the lower limit value means that the Li element is deficient from the entire positive electrode active material, and the initial charging and discharging efficiency is likely to deteriorate.

When the mixing step of the intermediate product and the liquid is carried out under the appropriate conditions as described above, the value of [PT(Li)/IT(Li)]/(PS/IS) can be 0.1 to 0.65. The value of [PT(Li)/IT(Li)]/(PS/IS) is preferably 0.2 to 0.63, more preferably 0.25 to 0.6, and particularly preferably 0.3 to 0.55. When the value of [PT(Li)/IT(Li)]/(PS/IS) is 0.1 to 0.65, deficiencies of the Li element in the crystal lattice on the surfaces of the secondary particles are suppressed, and CAM having a large BET specific surface area can be produced.

Here, IT(Li) contained in the intermediate product can be quantified by the same procedure as for PT(Li) described above.

### (5) Drying of Second Mixture

Then, the second mixture is dried to evaporate the liquid (hereinafter, referred to as the drying step in some cases). In the method for producing CAM of the present embodiment, the second mixture is not filtered before the drying step. The proportion of the liquid contained in the second mixture is small, and thus the liquid can be efficiently evaporated even without filtration.

As the drying method, drying under reduced pressure, vacuum drying, blowing, heating, combinations thereof, and the like are exemplary examples. The drying step preferably includes heating the second mixture at 100 to 400° C.

As conditions for drying under reduced pressure, 0.3 atmospheres or less is an exemplary example. The temperature during drying under reduced pressure or vacuum drying is preferably 100 to 200° C.

For drying by blowing, a hot air drier can be used. The temperature during drying by blowing is preferably 100 to 400° C.

The temperature during drying by heating is preferably 100° C. or higher, more preferably 110° C. or higher, and still more preferably 120° C. or higher from the viewpoint that it is possible to prevent a decrease in the charge capacity due to remaining moisture. In addition, the temperature is not particularly limited, but is preferably 400° C. or lower, more preferably, 350° C. or lower, and particularly preferably 300° C. or lower from the viewpoint that recalcining of the grain boundary is prevented and CAM having the composition of the present embodiment can be obtained.

The upper limit value and lower limit value of the temperature during heat drying can be randomly combined together. For example, the heat treatment temperature is preferably 100 to 400° C., more preferably 110 to 350° C., and still more preferably 120 to 300° C.

As the atmosphere during the drying treatment, an oxygen atmosphere, a nitrogen atmosphere, an atmosphere in which air having a water vapor concentration and a carbon dioxide concentration equal to or less than one-hundredth of those of ambient air is used, a reduced pressure atmosphere, or a vacuum atmosphere is an exemplary example. When the drying step is carried out in the above-described atmosphere, a reaction between CAM and moisture or carbon dioxide in the atmosphere during the drying step is suppressed, and CAM containing a few impurities can be obtained.

CAM can be obtained by the above-described production method. The values of {Li(A)/(Ni+M)}/PS, PT(Li)/PS, and Li/(Ni+M) of CAM can be adjusted by adjusting the production conditions in the mixing step and the drying step.

### <Lithium Secondary Battery>

Next, the configuration of a lithium secondary battery that is suitable in a case where CAM of the present embodiment is used will be described.

Furthermore, a positive electrode for a lithium secondary battery that is suitable in a case where CAM of the present embodiment is used (hereinafter, referred to as the positive electrode in some cases) will be described.

Furthermore, a lithium secondary battery that is suitable for an application of a positive electrode will be described.

An example of the lithium secondary battery that is suitable in a case where CAM of the present embodiment is used has a positive electrode, a negative electrode, a separator interposed between the positive electrode and the negative electrode, and an electrolytic solution disposed between the positive electrode and the negative electrode.

An example of the lithium secondary battery has a positive electrode, a negative electrode, a separator interposed between the positive electrode and the negative electrode, and an electrolytic solution disposed between the positive electrode and the negative electrode.

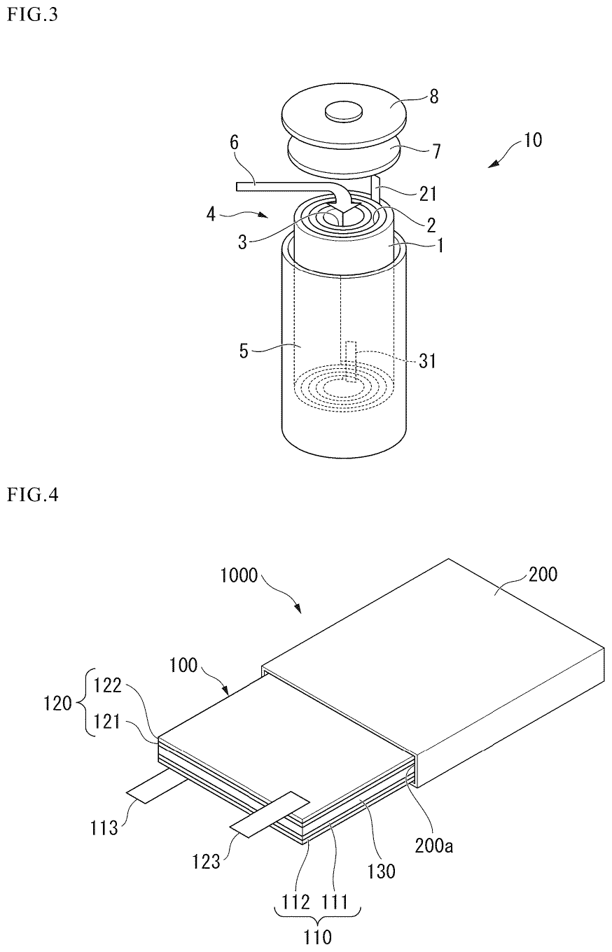

FIG. 3 is a schematic view showing an example of a lithium secondary battery. A cylindrical lithium secondary battery 10 of the present embodiment is produced as described below.

First, as shown in FIG. 3, a pair of separators 1 having a strip shape, a strip-shaped positive electrode 2 having a positive electrode lead 21 at one end, and a strip-shaped negative electrode 3 having a negative electrode lead 31 at one end are laminated in the order of the separator 1, the positive electrode 2, the separator 1, and the negative electrode 3 and are wound to form an electrode group 4.

Next, the electrode group 4 and an insulator, not shown, are accommodated in a battery can 5, and the can bottom is then sealed. The electrode group 4 is impregnated with an electrolytic solution 6, and an electrolyte is disposed between the positive electrode 2 and the negative electrode 3. Furthermore, the upper portion of the battery can 5 is sealed with a top insulator 7 and a sealing body 8, whereby the lithium secondary battery 10 can be produced.

As the shape of the electrode group 4, for example, a columnar shape in which the cross-sectional shape becomes a circle, an ellipse, a rectangle, or a rectangle with rounded corners when the electrode group 4 is cut in a direction perpendicular to the winding axis can be an exemplary example.

In addition, as a shape of the lithium secondary battery having the electrode group 4, a shape specified by IEC60086, which is a standard for a battery specified by the International Electrotechnical Commission (IEC), or by JIS C 8500 can be adopted. For example, shapes such as a cylindrical type and a square type can be exemplary examples.

Furthermore, the lithium secondary battery is not limited to the winding-type configuration and may have a laminate-type configuration in which the laminated structure of the positive electrode, the separator, the negative electrode, and the separator is repeatedly overlaid. As the laminate-type lithium secondary battery, a so-called coin-type battery, button-type battery, or paper-type (or sheet-type) battery can be an exemplary example.

Hereinafter, each configuration will be described in order.

### (Positive Electrode)

The positive electrode can be produced by, first, preparing a positive electrode mixture containing CAM, a conductive material, and a binder and supporting the positive electrode mixture by a positive electrode current collector.

### (Negative Electrode)

The negative electrode in the lithium secondary battery needs to be a material which can be doped with lithium ions and from which lithium ions can be de-doped at a potential lower than that of the positive electrode, and an electrode in which a negative electrode mixture containing a negative electrode active material is supported by a negative electrode current collector and an electrode formed of a negative electrode active material alone can be exemplary examples.

For the positive electrode, separator, negative electrode, and electrolytic solution that configure the lithium secondary battery, the configuration, materials, and production method described in [0113] to [0140] of WO2022/113904A1, for example, can be used.

### <All-Solid-State Lithium Secondary Battery>

Next, a positive electrode for which CAM according to an aspect of the present invention is used as CAM of an all-solid-state lithium secondary battery and an all-solid-state lithium secondary battery having this positive electrode will be described while describing the configuration of an all-solid-state lithium secondary battery.

FIG. 4 is a schematic view showing an example of an all-solid-state lithium secondary battery of the present embodiment. An all-solid-state lithium secondary battery 1000 shown in FIG. 4 has a laminate 100 having a positive electrode 110, a negative electrode 120, and a solid electrolyte layer 130 and an exterior body 200 accommodating the laminate 100. In addition, the all-solid-state lithium secondary battery 1000 may have a bipolar structure in which CAM and a negative electrode active material are disposed on both sides of a current collector. As specific examples of the bipolar structure, for example, the structures described in JP-A-2004-95400 are exemplary examples. A material that configures each member will be described below.

The laminate 100 may have an external terminal 113 that is connected to a positive electrode current collector 112 and an external terminal 123 that is connected to a negative electrode current collector 122. In addition, the all-solid-state lithium secondary battery 1000 may have a separator between the positive electrode 110 and the negative electrode 120.

The all-solid-state lithium secondary battery 1000 further has an insulator, not shown, that insulates the laminate 100 and the exterior body 200 from each other and a sealant, not shown, that seals an opening portion 200a of the exterior body 200.

As the exterior body 200, a container formed of a highly corrosion-resistant metal material such as aluminum, stainless steel or nickel-plated steel can be used. In addition, as the exterior body 200, a container obtained by processing a laminate film having at least one surface on which a corrosion resistant process has been performed into a bag shape can also be used.

As the shape of the all-solid-state lithium secondary battery 1000, for example, shapes such as a coin type, a button type, a paper type (or a sheet type), a cylindrical type, a square type, and a laminate type (pouch type) can be exemplary examples.

As an example of the all-solid-state lithium secondary battery 1000, a form in which one laminate 100 is provided is shown in the drawings, but the present embodiment is not limited thereto. The all-solid-state lithium secondary battery 1000 may have a configuration in which the laminate 100 is used as a unit cell and a plurality of unit cells (laminates 100) is sealed inside the exterior body 200.

### (Positive Electrode)

The positive electrode 110 of the present embodiment has a positive electrode active material layer 111 and a positive electrode current collector 112.

The positive electrode active material layer 111 contains CAM, which is one aspect of the present invention described above, and a solid electrolyte. In addition, the positive electrode active material layer 111 may contain a conductive material and a binder.

### (Negative Electrode)

The negative electrode 120 has a negative electrode active material layer 121 and the negative electrode current collector 122. The negative electrode active material layer 121 contains a negative electrode active material. In addition, the negative electrode active material layer 121 may contain a solid electrolyte and a conductive material. As the negative electrode active material, the negative electrode current collector, the solid electrolyte, the conductive material, and a binder, those described above can be used.

For the all-solid-state lithium secondary battery, the configuration, materials, and production method described in [0151] to [0181] of WO2022/113904A1, for example, can be used.

In the lithium secondary batteries having the configuration as above, since CAM that is produced by the present embodiment described above is used as CAM, it is possible to improve the initial charging and discharging efficiencies and the cycle retention rates of the lithium secondary batteries for which this CAM is used.

In addition, since the positive electrodes having the above-described configuration have CAM for the lithium secondary battery having the above-described configuration, it is possible to improve the initial charging and discharging efficiencies and the cycle retention rates of the lithium secondary batteries.

Furthermore, the lithium secondary batteries having the above-described configuration have the above-described positive electrodes and thus become secondary batteries having high initial charging and discharging efficiencies and high cycle retention rates.

Another aspect of the present invention includes the following aspects.
[13] CAM, containing LiMO containing the Ni element and the element M and a lithium compound, in which LiMO has a layered rock-salt structure, and the value of the {Li(A)/(Ni+M)}/PS is 0.5 to 2.5 g/m².
[14] CAM according to [13], in which the value of the PT(Li)/PS is 0.2 to 0.8 mass %·g/m².
[15] CAM according to [14], in which the value of the PT(Li) is 0.2 to 0.8 mass %.
[16] CAM according to any one of [13] to [15], in which CAM is represented by the above composition formula (I).
[17] CAM according to any one of [13] to [16], in which the PS is 0.35 to 1.5 m²/g.
[18] CAM according to any one of [13] to [17], in which the Li/(Ni+M) is 1.5 to 7.6.
[19] CAM according to any one of [13] to [18], in which a 50% cumulative volume particle diameter is 8 to 20 μm.
[20] A positive electrode for a lithium secondary battery, containing CAM according to any one of [13] to [19].
[21] A lithium secondary battery, containing the positive electrode for the lithium secondary battery according to [20].
[22] A method for producing CAM, including a calcining step of calcining a first mixture of MCC containing the Ni element and the element M and a lithium compound to obtain an intermediate product, a mixing step of mixing the intermediate product and a liquid capable of dissolving the lithium compound to obtain a second mixture, and a drying step of evaporating the liquid from the second mixture to obtain CAM, in which a value of the [PT(Li)/IT(Li)]/(PS/IS) is 0.2 to 0.6.
[23] The method for producing CAM according to [22], in which the value of the PT(Li)/IT(Li) is 0.85 to 1.1.
[24] The method for producing CAM according to or [23], in which the liquid contains at least one of water and alcohol.
[25] The method for producing CAM according to any one of [22] to [24], in which the drying step includes heating the second mixture at 110 to 350° C.

Still another aspect of the present invention includes the following aspects.
[13′] CAM comprising LiMO containing the Ni element and the element M and a lithium compound, in which LiMO has a layered rock-salt structure, and the value of the {Li(A)/(Ni+M)}/PS is 1.5 to 2.5 g/m².
[14′] CAM according to [13′], in which the value of the PT(Li)/PS is 0.5 to 0.7 mass %·g/m².
[15′] CAM according to [14′], in which the value of the PT(Li) is 0.35 to 0.55 mass %.
[16′] CAM according to any one of [13] to [15′], in which CAM is represented by the above composition formula (I′).
[17′] CAM according to any one of [13′] to [16′], in which the BET specific surface area PS is 0.5 to 1.0 m²/g.
[18′] CAM according to any one of [13′] to [17′], in which the Li/(Ni+M) is 5.0 to 7.6.
[19′] CAM according to any one of [13′] to [18′], in which a 50% cumulative volume particle diameter is 15 to 20 μm.
[20′] A positive electrode for a lithium secondary battery, containing CAM according to any one of [13′] to [19′].
[21′] A lithium secondary battery, containing the positive electrode for the lithium secondary battery according to [20′].
[22′] A method for producing CAM, including a calcining step of calcining a first mixture of MCC containing the Ni element and the element M and a lithium compound to obtain an intermediate product, a mixing step of mixing the intermediate product and a liquid capable of dissolving the lithium compound to obtain a second mixture, and a drying step of evaporating the liquid from the second mixture to obtain CAM, in which the value of the [PT(Li)/IT(Li)]/(PS/IS) is 0.35 to 0.55.
[23′] The method for producing CAM according to [22′], in which the value of the PT(Li)/IT(Li) is 0.9 to 1.1.
[24′] The method for producing CAM according to [22′] or [23′], in which the liquid contains at least one of water and alcohol.
[25′] The method for producing CAM according to any one of [22′] to [24′], in which the drying step includes heating the second mixture at 110 to 200° C.

### EXAMPLES

Hereinafter, the present invention will be described in detail by showing examples, but the present invention is not limited to the following description.

### <Composition Analysis>

The composition analysis of CAM that was produced by a method to be described below was performed in accordance with the method described in the above section <Composition>.

### <Cumulative Volume Particle Size>

The 50% cumulative volume particle diameter D₅₀ (μm) of CAM that was produced by a method to be described below was measured in accordance with the procedure described in the above section <Measurement of cumulative volume particle size>.

### <Measurement of BET Specific Surface Area>

Using the powder of the intermediate product or CAM that was obtained by a method to be described below as a material to be measured, the BET specific surface area (unit: m²/g) was measured in accordance with the procedure described in the above section <BET specific surface area>. The BET specific surface area of the intermediate product is defined as IS, and the BET specific surface area of CAM is defined as PS.

### <X-Ray Photoelectron Spectroscopy (XPS)>

The X-ray photoelectron spectrometer (K-Alpha manufactured by Thermo Fisher Scientific Inc.) was used to measure the spectra of Li1s and Ni2p and the spectrum of the element M (cobalt 2p, aluminum 2p, and manganese 2p in Examples to be described below). AlKα rays are used as the X-ray source, and a neutralizing gun (acceleration voltage: 0.3 V, current: 100 μA) was used for charge neutralization during measurement. Measurement conditions were Spot size=400 μm, Pass Energy=50 eV, Step=0.1 eV, and Dwell time=500 ms. With respect to the obtained XPS spectra, the peak areas and atomic concentrations to be described below were calculated using Avantage data system manufactured by Thermo Fisher Scientific Inc. In the carbon 1s spectrum, charge correction was carried out with the peak attributable to surface contaminating hydrocarbon set at 284.6 eV.

### Measurement of Peak Areas P (A) and P(a)

With respect to the spectrum having binding energy of 54.5±3 eV, that is, the Li1s spectrum, waveform separation was carried out with the half width of the peak A having a peak top at 53.5±1.0 eV set at 1.0±0.2 eV and the half with of the peak a having a peak top at 55.5±1.0 eV set at 1.5±0.3 eV. P(A) and P(a), which are the peak areas of the obtained peak A and peak a were calculated.

### Measurement of Atomic Ratio Li/(Ni+M), Li(A)/(Ni+M), and Li(a)/(Ni+M)

With respect to the spectra of Li1s and Ni2p and the spectrum of the element M (cobalt 2p, aluminum 2p, and manganese 2p in Examples to be described below), from the peak area of each element's spectrum and the sensitivity coefficient of each element, the atomic concentration (atm %) of each element in the entire elements was calculated, and additionally Li/(Ni+M), which is the ratio of the elements, was calculated. Additionally, from P(A) and P(a), Li(A) and Li(a), which are the atomic concentrations of the Li elements derived from the peak A and the peak a, respectively, were calculated, and Li(a)/(Ni+M) and Li(A)/(Ni+M), the ratios of each of the Li element components to the Ni element and the element M, were each calculated.

### <Neutralization Titration and Measurement of PT(Li)>

5 g of an intermediate product to be obtained by the production method to be described below or CAM and 100 g of pure water were mixed to obtain a slurry. After the slurry was stirred for 5 minutes, CAM was filtered, 0.1 mol/L hydrochloric acid was added dropwise to 60 g of the remaining filtrate, and the pH of the filtrate was measured with a pH meter. The amount titrated of hydrochloric acid at pH=8.3±0.1 was defined as A ml, the amount titrated of hydrochloric acid at pH-4.5±0.1 was defined as B ml, and the concentrations of lithium carbonate and lithium hydroxide remaining in CAM were calculated by the following calculation formulas. In the following formulas, calculation was carried out with the molecular weight of lithium carbonate set to 73.882 and the molecular weight of lithium hydroxide set to 23.941.

$$\begin{matrix}Lithium carbonate concentration ( \% ) = 0.1 \times ( B - A ) / 1000 \times 73.882 / ( 20 \times 60 / 100 ) \times 100 \\ Lithium hydroxide concentration ( \% ) = 0.1 \times ( 2 A - B ) / 1000 \times 23.941 / ( 20 \times 60 / 100 ) \times 100\end{matrix}$$

From the calculated lithium carbonate concentration and lithium hydroxide concentration, PT(Li) was calculated as the summed value of the concentrations of the amount of the Li element in each lithium compound. In the following formula, calculation was carried out with the molecular weight of lithium set to 6.941. In the following formula, the formula weight of lithium carbonate was set to 73.882, and the formula weight of lithium hydroxide was set to 23.941.

$$PT ( Li ) ( \% ) = lithium carbonate concentration ( \% ) \times ( 2 \times 6.9 \; 41 / 73.882 ) + lithium hydroxide concentration ( \% ) \times ( 6.941 / 23.941 )$$

### <Production of Positive Electrode for Lithium Secondary Battery>

A paste-like positive electrode mixture was prepared by adding and kneading CAM that was obtained by the production method to be described below, a conductive material (acetylene black), and a binder (PVdF) in ratios at which the composition of CAM:conductive material:binder=92:5:3 (mass ratio) was achieved. During the preparation of the positive electrode mixture, N-methyl-2-pyrrolidone was used as an organic solvent.

The obtained positive electrode mixture was applied to an Al foil having a thickness of 40 μm, which was to serve as a current collector, and dried in a vacuum at 150° C. for 8 hours, thereby obtaining a positive electrode for a lithium secondary battery. The electrode area of this positive electrode for the lithium secondary battery was set to 1.65 cm².

### <Production of Lithium Secondary Battery (Coin-Type Half Cell)>

The following operation was carried out in a glove box under an argon atmosphere.

The above-described positive electrode for the lithium secondary battery was placed on the lower lid of a part for a coin-type battery R2032 (manufactured by Hohsen Corp.) with the aluminum foil surface facing downward, and a laminated film separator (16 μm-thick) having a heat-resistant porous layer laminated on a polyethylene porous film was placed on the positive electrode. An electrolytic solution (300 μl) was poured thereinto. The electrolytic solution used was a liquid obtained by dissolving LiPF₆ in a liquid mixture of ethylene carbonate, dimethyl carbonate, and ethyl methyl carbonate in 30:35:35 (volume ratio) so as to be 1 mol/l.

Next, lithium metal was used as a negative electrode and placed on the upper side of the separator. An upper lid was placed through a gasket and caulked using a caulking machine, thereby producing a lithium secondary battery (coin-type half cell R2032; hereinafter, referred to as “coin-type half cell” in some cases).

### <Initial Charging and Discharging Test>

An initial charging and discharging test under the conditions described in the above section <Initial charging and discharging> was performed using the half cell produced in the section <Production of Lithium secondary battery (coin-type half cell)>.

### <Cycle Test (Cycle Retention Rate)>

A cycle test was performed in accordance with the procedure described in the above section <Cycle test>, and the cycle retention rate was calculated.

### Example 1

After water was poured into a reaction vessel equipped with a stirrer and an overflow pipe, an aqueous solution of sodium hydroxide was added thereto, and the liquid temperature was held at 50° C.

A nickel sulfate aqueous solution and a cobalt sulfate aqueous solution were mixed together in ratios at which the mole ratio of Ni and Co reached 0.88:0.09, thereby preparing a liquid mixture 1. Further as a raw material liquid containing Al, an aluminum sulfate aqueous solution was prepared.

Next, the liquid mixture 1 and an ammonium sulfate aqueous solution were continuously added into the reaction vessel under stirring in ratios at which the mole ratio of Ni, Co, and Al reached 0.88:0.09:0.03, and an ammonium sulfate aqueous solution, as a complexing agent, was continuously added. An aqueous solution of sodium hydroxide was timely added dropwise such that the pH of the solution in the reaction vessel reached 11.7 (measurement temperature: 40° C.), and a reaction precipitate 1 was obtained.

The reaction precipitate 1 was washed, then, dehydrated, dried, and sieved, thereby obtaining a metal composite hydroxide 1 containing Ni, Co, and Al.

The metal composite hydroxide 1 was held and heated at 650° C. for 5 hours in the atmospheric atmosphere and cooled to room temperature, thereby obtaining a metal composite oxide 1.

Lithium hydroxide was weighed so that the amount (mole ratio) of Li with respect to the total amount 1 of Ni, Co, and Al that were contained in the metal composite oxide 1 reached 1.06. The metal composite oxide 1 and lithium hydroxide were mixed to obtain a first mixture 1.

Then, the obtained first mixture 1 was filled into a saggar made of alumina, injected into a roller hearth kiln, and preliminary calcined at a maximum temperature of 650° C. for 5 hours to obtain a preliminary calcined product 1. The preliminary calcined product 1 was filled into a saggar made of alumina, injected into a roller hearth kiln, and calcined at maximum temperature of 760° C. for 5 hours to obtain an intermediate product 1.

The intermediate product 1 and pure water cooled to 5° C. were mixed for 15 minutes to produce a second mixture 1. The proportion of pure water with respect to the total mass of the second mixture 1 was 15 mass %. The second mixture 1 was clay-like. The second mixture 1 was vacuum dried at 150° C. for 8 hours to obtain CAM-11. The composition ratio (mole ratio) of CAM-1 is Li/(Ni+Co+Al)=1.06, and in the composition formula (I), x was 0.03, y was 0.09, and z was 0.03.

### Comparative Example 1

The intermediate product 1 obtained in the process of Example 1 was subjected to no subsequent mixing and drying treatment, and used as CAM-C1, as it was. The compositional ratio (mole ratio) was Li/(Ni+Co+Al)=1.06, and in the composition formula (I), x was 0.03, y was 0.09, and z was 0.03.

### Example 2

The metal composite oxide 1 obtained in the process of Example 1 was used, and lithium hydroxide was weighed so that the amount (mole ratio) of Li with respect to the total amount 1 of Ni, Co, and Al that were contained in the metal composite oxide 1 reached 0.99. The metal composite oxide 1 and lithium hydroxide were mixed to obtain a first mixture 2.

Then, the obtained first mixture 2 was calcined under the same conditions as in Example 1 to obtain an intermediate product 2.

The intermediate product 2 and pure water cooled to 5° C. were mixed for 10 minutes to produce a second mixture 2. The proportion of pure water with respect to the total mass of the second mixture 2 was 20 mass %. The second mixture 2 was past-like. The second mixture 2 was vacuum dried at 150° C. for 8 hours to obtain CAM-2. The composition ratio (mole ratio) of CAM-2 was Li/(Ni+Co+Al)=0.99, and in the composition formula (I), x was −0.01, y was 0.09, and z was 0.03.

### Comparative Example 2

Pure water cooled to 5° C. was added to the intermediate product 2 obtained in the process of Example 2, and stirring was carried out for 20 minutes to produce a second mixture C2. The second mixture C2 was slurry-like. The proportion of pure water with respect to the total mass of the second mixture C2 was 70 mass %. After washing, the second mixture C2 was filtered, and the filtrate was vacuum dried at 150° C. for 8 hours to obtain CAM-C2. The composition ratio (mole ratio) of CAM-C2 was Li/(Ni+Co+Al)=0.97, and in the composition formula (I), x was −0.02, y was 0.09, and z was 0.03.

### Example 3

After water was poured into a reaction vessel equipped with a stirrer and an overflow pipe, an aqueous solution of sodium hydroxide was added thereto, and the liquid temperature was held at 50° C.

Next, a nickel sulfate aqueous solution, a cobalt sulfate aqueous solution, and a manganese sulfate aqueous solution were mixed together in ratios at which the mole ratio of Ni, Co, and Mn reached 0.83:0.12:0.05, thereby preparing a liquid mixture 2.

Next, this liquid mixture 2 and an ammonium sulfate aqueous solution, as a complexing agent, were continuously added into the reaction vessel under stirring. An aqueous solution of sodium hydroxide was timely added dropwise such that the pH of the solution in the reaction vessel reached 12.2 (measurement value at the liquid temperature of the aqueous solution of 40° C.), and a reaction precipitate was obtained. The obtained reaction precipitate was washed, then, dehydrated, dried, and sieved, thereby obtaining a metal composite hydroxide 2 containing Ni, Co, and Mn.

Lithium hydroxide was weighed so that the amount (mole ratio) of Li with respect to the total amount 1 of Ni, Co, and Mn that were contained in the metal composite hydroxide 2 reached 1.04. The metal composite hydroxide 2 and lithium hydroxide were mixed to obtain a first mixture 3.

Then, the obtained first mixture 3 was filled into a saggar made of alumina, injected into a roller hearth kiln, and preliminary calcined at a maximum temperature of 650° C. for 5 hours to obtain a preliminary calcined product 3. The preliminary calcined product 3 was filled into a saggar made of alumina, injected into a roller hearth kiln, and calcined at maximum temperature of 780° C. for 5 hours to obtain an intermediate product 3.

The intermediate product 3 and pure water at ordinary temperature (about 20° C.) were mixed for 20 minutes to produce a second mixture 3. The proportion of pure water with respect to the total mass of the second mixture 3 was 15 mass %. The second mixture 3 was clay-like. The second mixture 3 was vacuum dried at 150° C. for 8 hours to obtain CAM-3. The composition ratio (mole ratio) of CAM-3 was Li/(Ni+Co+Mn)=1.04, and in the composition formula (I), x was 0.02, y was 0.12, and z was 0.05.

### Comparative Example 3

The intermediate product 3 obtained in the process of Example 3 was subjected to no subsequent mixing and drying treatment, and used as CAM-C3, as it was. The composition ratio (mole ratio) of CAM-C3 was Li/(Ni+Co+Mn)=1.04, and in the composition formula (I), x was 0.02, y was 0.12, and z was 0.05.

D₅₀ of CAM-1 to CAM-3 and CAM-C1 to CAM-C3 in Examples 1 to 3 and Comparative Examples 1 to 3, IS of the intermediate products, PS of CAM, the values of atomic ratios Li(A)/(Ni+M) and {Li(A)/(Ni+M)}/PS obtained by XPS analysis of CAM, Li/(Ni+M), the values of IT(Li) of the intermediate product, PT(Li) of CAM, and [PT(Li)/IT(Li)]/(PS/IS) obtained by neutralization titration, and the initial charging and discharging efficiency and cycle retention rate of the coin-type half cell in which each CAM was used are shown in Table 1. “wt %” in Table 1 indicates “mass %”.

TABLE 1

| | | | | | | | | | | | | Initial | Cycle |
|---|---|---|---|---|---|---|---|---|---|---|---|---|---|
| | | Li(A)/ | | | [Li(A)/ | Li/ | | PT(Li)/ | | | | charging and | reten- |
| | | (Ni + M) | | | (Ni + | (Ni + M) | | PS | | | [PT(Li)/ | discharging | tion |
| | D₅₀ | determined | IS | PS | M)}/PS | determined | PT(Li) | (wt % · | IT(Li) | PT(Li)/ | IT(Li)]/ | efficiency | rate |
| | (μm) | by XPS | (m²/g) | (m²/g) | (g/m²) | by XPS | (wt %) | g/m²) | (wt %) | IT(Li) | (PS/IS) | (%) | (%) |
| Example 1 | 17 | 1.7 | 0.29 | 0.71 | 2.4 | 7.4 | 0.44 | 0.62 | 0.43 | 1.0 | 0.42 | 89.4 | 85.3 |
| Example 2 | 14 | 0.53 | 0.28 | 0.93 | 0.57 | 0.80 | 0.25 | 0.27 | 0.26 | 0.96 | 0.29 | 86.3 | 80.2 |
| Example 3 | 13 | 0.64 | 0.31 | 0.53 | 1.2 | 2.2 | 0.31 | 0.58 | 0.34 | 0.91 | 0.53 | 86.6 | 82.8 |
| Comparative | 17 | 2.0 | — | 0.29 | 6.9 | 6.1 | 0.43 | 1.5 | — | — | — | 84.8 | 85.1 |
| Example 1 | | | | | | | | | | | | | |
| Comparative | 14 | 0.46 | 0.28 | 1.41 | 0.33 | 0.58 | 0.06 | 0.04 | 0.26 | 0.23 | 0.05 | 88.0 | 70.6 |
| Example 2 | | | | | | | | | | | | | |
| Comparative | 13 | 0.96 | — | 0.31 | 3.1 | 3.8 | 0.34 | 1.1 | — | — | — | 83.2 | 94.8 |
| Example 3 | | | | | | | | | | | | | |

From the comparison of Example 1 and Comparative 1 and of Example 3 and Comparative Example 3, the BET specific surface areas of CAMs in Examples 1 and 3 are larger than those in Comparative Examples 1 and 3, respectively. Accordingly, in Example 1 and Example 3, it is considered that the unreacted lithium compound inside the secondary particles of CAM migrate to the surfaces of the secondary particles due to mixing of the first mixture and the liquid and voids were generated inside the secondary particles.

It can be said that Li(A)/(Ni+M) was not greatly different between Example 1 and Comparative Example 1. That is, it can be said that mixing the first mixture and the liquid performed in Example 1 was able to increase the BET specific surface area without excessive deficiencies of the Li element in the crystal lattice on the surfaces of the secondary particles of CAM.

From the comparison of Example 2 and Comparative Example 2, it can be said that the BET specific surface area of CAM in Example 2 is smaller than that in Comparative Example 2. Accordingly, in Comparative Example 2, it is considered that the unreacted lithium compound inside the secondary particles of CAM migrated to the surfaces of the secondary particles due to mixing of the first mixture and the liquid and the BET specific surface area more increased due to removal of the lithium compound by filtration.

The initial charging and discharging efficiency of the coin-type half cells in which CAM in each of Examples 1 to 3 was used was 86.3% or more, and the cycle retention rate thereof was 80.2% or more.

On the other hand, in Comparative Example 1 and Comparative Example 3, in which {Li(A)/(Ni+M)}/PS is 3.1 g/m² or more, the value of the initial charging and discharging efficiency was low. In Comparative Example 2, in which {Li/(Ni+M)}/PS was 0.33 g/m², the cycle retention rate was a low value.

### INDUSTRIAL APPLICABILITY

According to the present invention, it is possible to provide CAM capable of obtaining a secondary battery having high initial charging and discharging efficiency and a high cycle retention rate, a positive electrode for a lithium secondary battery and a lithium secondary battery in which CAM is used, and a method for producing CAM.

### REFERENCE SIGNS LIST

1: Separator, 2: Positive electrode, 3: Negative electrode, 4: Electrode group, 5: Battery can, 6: Electrolytic solution, 7: Top insulator, 8: Sealing body, 10: Lithium secondary battery, 21: Positive electrode lead, 31: Negative electrode lead, 40: Intermediate product, 41: Primary particles, 42: Lithium compound, 50: CAM, 100: Laminate, 110: Positive electrode, 111: Positive electrode active material layer, 112: Positive electrode current collector, 113: External terminal, 120: Negative electrode, 121: Negative electrode active material layer, 122: Negative electrode current collector, 123: External terminal, 130: Solid electrolyte layer, 200: Exterior body, 200a: Opening portion, 1000: All-solid-state lithium secondary battery

1. A positive electrode active material for a lithium secondary battery, comprising a lithium metal composite oxide containing a Ni element and an element M, and a lithium compound,
wherein the lithium metal composite oxide has a layered rock-salt structure,
the element M represents one or more elements selected from the group consisting of Co, Mn, Fe, Cu, Ti, Mg, Al, W, Mo, Nb, Zn, Sn, Zr, Ga, B, Si, S, and P, and
in a spectrum obtained by X-ray photoelectron spectroscopy measurement of surfaces of particles of the positive electrode active material for the lithium secondary battery, the positive electrode active material has a peak X derived from a Li element having a peak top at 54.5±3.0 eV; when, upon waveform separation of the peak X derived from the Li element into a peak (A) having a peak top at 53.5±1.0 eV and a peak (a) having a peak top at 55.5±1.0 eV, an atomic ratio calculated from the peak (A), a peak derived from the Ni element, and a peak derived from the element M is defined as Li(A)/(Ni+M), and a BET specific surface area of the positive electrode active material for the lithium secondary battery measured by a nitrogen adsorption method is defined as PS, a value of {Li(A)/(Ni+M)}/PS is 0.4 to 2.6 g/m².

2. The positive electrode active material for the lithium secondary battery according to claim 1,
wherein a value of PT(Li)/PS, which is a ratio of PT(Li) that is a mass proportion of the Li element derived from the lithium compound in the positive electrode active material for the lithium secondary battery, determined by neutralization titration of a filtrate obtained by filtering a slurry obtained by mixing 5 g of the positive electrode active material for the lithium secondary battery and 100 g of pure water, to the BET specific surface area PS, is 0.1 to 1.0 mass %·g/m², and
the PT(Li) is determined from an amount titrated of 0.1 N hydrochloric acid when titration is carried out with 0.1 mol/L hydrochloric acid until pH of the filtrate reaches 4.5.

3. The positive electrode active material for the lithium secondary battery according to claim 2,
wherein the value of the PT(Li) is 0.15 to 1 mass %.

4. The positive electrode active material for the lithium secondary battery according to claim 1,
wherein the positive electrode active material for the lithium secondary battery is represented by a composition formula (I), 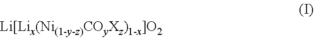
(in the formula (I), X represents one or more elements selected from the group consisting of Mn, Fe, Cu, Ti, Mg, Al, W, Mo, Nb, Zn, Sn, Zr, Ga, B, Si, S, and P, and −0.1≤x≤0.2, 0≤y ≤0.2, 0<z≤0.2, and y+z≤0.3 are satisfied.)

5. The positive electrode active material for the lithium secondary battery according to claim 1,
wherein the PS is 0.3 to 2 m²/g.

6. The positive electrode active material for the lithium secondary battery according to claim 1,
wherein Li/(Ni+M), which is an atomic ratio calculated from the peak X derived from the Li element, the peak derived from the Ni element, and the peak derived from the element M, is 0.8 to 8.

7. The positive electrode active material for the lithium secondary battery according to claim 1,
wherein a 50% cumulative volume particle diameter is 3 to 30 μm.

8. A positive electrode for a lithium secondary battery, comprising:
the positive electrode active material for the lithium secondary battery according to claim 1.

9. A lithium secondary battery comprising:
the positive electrode for the lithium secondary battery according to claim 8.

10. A method for producing a positive electrode active material for a lithium secondary battery, comprising:
a calcining step of calcining a first mixture of a metal composite compound containing a Ni element and an element M and a lithium compound to obtain an intermediate product,
a mixing step of mixing the intermediate product and a liquid capable of dissolving the lithium compound to obtain a second mixture, and
a drying step of evaporating the liquid from the second mixture to obtain the positive electrode active material for the lithium secondary battery,
wherein the element M is one or more elements selected from the group consisting of Co, Mn, Fe, Cu, Ti, Mg, Al, W, Mo, Nb, Zn, Sn, Zr, Ga, B, Si, S, and P, and
when a BET specific surface area of the intermediate product is defined as IS, a mass proportion of a Li element derived from the lithium compound contained in the intermediate product is defined as IT(Li), a BET specific surface area of the positive electrode active material for the lithium secondary battery after the drying step is defined as PS, and a mass proportion of a Li element derived from the lithium compound contained in the positive electrode active material for the lithium secondary battery after the drying step is defined as PT(Li), a value of [PT(Li)/IT(Li)]/(PS/IS) is 0.1 to 0.65.

11. The method for producing the positive electrode active material for the lithium secondary battery according to claim 10,
wherein the value of the PT(Li)/IT(Li) is 0.8 to 1.2.

12. The method for producing the positive electrode active material for the lithium secondary battery according to claim 10,
wherein the liquid contains at least one of water and alcohol.

13. The method for producing the positive electrode active material for the lithium secondary battery according to claim 10,
wherein the drying step includes heating the second mixture at 100 to 400° C.

14. The positive electrode active material for the lithium secondary battery according to claim 2,
wherein the positive electrode active material for the lithium secondary battery is represented by a composition formula (I), 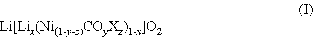
(in the formula (I), X represents one or more elements selected from the group consisting of Mn, Fe, Cu, Ti, Mg, Al, W, Mo, Nb, Zn, Sn, Zr, Ga, B, Si, S, and P, and −0.1≤x≤0.2, 0≤y ≤0.2, 0<z≤0.2, and y+z≤0.3 are satisfied.)

15. The positive electrode active material for the lithium secondary battery according to claim 2,
wherein the PS is 0.3 to 2 m²/g.

16. The positive electrode active material for the lithium secondary battery according to claim 2,
wherein Li/(Ni+M), which is an atomic ratio calculated from the peak X derived from the Li element, the peak derived from the Ni element, and the peak derived from the element M, is 0.8 to 8.

17. The positive electrode active material for the lithium secondary battery according to claim 2,
wherein a 50% cumulative volume particle diameter is 3 to 30 μm.
